(19) United States
(12) Patent Application Publication
(10) Pub. No.: US 2023/0363434 A1
(43) Pub. Date: Nov. 16, 2023

(54) MEAL PLANNING SYSTEM AND METHOD

(71) Applicant: Dinner Technologies, Inc., Ft. Lauderdale, FL (US)

(72) Inventors: Charles Whiteman, Ft. Lauderdale, FL (US); Aman Sharma, Ft. Lauderdale, FL (US)

(21) Appl. No.: 18/316,157

(22) Filed: May 11, 2023

Related U.S. Application Data
(60) Provisional application No. 63/340,729, filed on May 11, 2022.

(51) Int. Cl. A23L 33/00

(52) U.S. Cl. CPC A23L 33/30; A23V 2200/26

(57) ABSTRACT

A method for planning meals includes establishing a plurality of meal preference profiles for members of a group, establishing a group meal database, generating and presenting at least one meal option from the group meal database to the members of the group, receiving instructions from the members of the group as to whether to discard the at least one meal option presented to the member or select the at least one meal option presented to the member, establishing a group recommendation meal option based on the selections of the at least one meal option among the group, soliciting feedback from the members of the group in association with the group recommendation meal option, and updating the group meal database based on the feedback from the members of the group.

### CROSS-REFERENCE TO RELATED APPLICATIONS

This application claims the benefit of U.S. Provisional Patent Application Ser. No. 63/340,729, filed on May 11, 2022, the entire disclosure of which is hereby incorporated by reference in its entirety.

### FIELD OF THE DISCLOSURE

The present disclosure relates to the field of culinary arts. More particularly, the present disclosure relates to meal planning systems and methods.

### BACKGROUND

Meal planning is an often stressful and tedious task, especially for groups of people like families that can have many food requirements and preferences. A typical meal planning strategy involves the steps of locating recipes that are satisfactory for everyone in the group, preparing a grocery shopping list for needed ingredients, locating and purchasing the ingredients from a store, preparing the recipes, and attempting to remember recipes that are flagged to be made again. Although attempts have been made to simplify and expedite the meal planning process, there remains a need for further improvements.

### SUMMARY OF THE DISCLOSURE

According to an aspect of the disclosure, a method for planning meals includes establishing a plurality of meal preference profiles for a plurality of members of a group, establishing a group meal database that includes a plurality of meal options flagged based on at least the established meal preference profiles, generating and presenting at least one meal option from the group meal database to each of the members of the group with at least one mobile device, receiving instructions from each of the members of the group with the at least one mobile device as to whether to discard the at least one meal option presented to the member or select the at least one meal option presented to the member, establishing a group recommendation meal option based on the selections of the at least one meal option among the group, soliciting feedback from each of the members of the group in association with the group recommendation meal option with the at least one mobile device, and updating the group meal database based on the feedback from the members of the group.

According to another aspect of the disclosure, a system for planning a meal includes a server computing device that comprises a processor and a memory including instructions that, when executed by the processor, cause the processor to establish meal preference profiles for a plurality of members of a group, establish a group meal database including a plurality of meal options flagged based on the established meal preference profiles, generate and present at least one meal option from the group meal database to each of the members of the group on at least one mobile device, receive instructions from each of the members of the group on the at least one mobile device as to whether to discard the at least one meal option presented to the member or select the at least one meal option presented to the member, establish a group recommendation meal option based on the selections of the at least one meal option among the group, solicit feedback from each of the members of the group in association with the group recommendation meal option on the at least one mobile device, and update the group meal database based on the feedback from the members of the group.

This method and system serve as an improved family meal planner at least because they facilitate fostering buy-in for the group recommendation meal option from everyone in the group based on likes and dislikes. The system and method also accommodate every member of the group's dietary styles, may automatically and accurately compute ingredient amounts, recommend dishes based on factors such as cooking skills, speed and kitchen tools available, and gradually improve meal option recommendations based on group preferences over time.

According to another aspect of the disclosure, a method for planning a meal includes receiving instructions from a user to generate a meal option from a mobile device, generating a meal option, where the meal option is generated based on a user created meal preference profile, presenting the meal option on the mobile device, receiving instructions from the user with the mobile device as to whether to discard the meal option or select the meal option, where receiving instructions from the user includes the user swiping on a screen of the mobile device in a first direction to discard the meal option, and the user swiping the screen of the mobile device in a second direction to select the meal option. If the user elects to discard the meal option, the method further includes presenting an additional meal option on the mobile device and receiving instructions from the user in association with the additional meal option.

This method provides inspiration for meal option ideas with personalized meal option suggestions, saves time planning meals and purchasing groceries, and gradually improves meal option recommendations based on indicated preferences over time.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1A generally illustrates a meal planning system according to the principles of the present disclosure;

FIG. 1B generally illustrates a computing device of the meal planning system according to the principles of the present disclosure;

FIG. 2 is a schematic flow diagram of a first embodiment of a method of meal planning;

FIG. 3 is a schematic flow diagram of a second embodiment of a method of meal planning;

FIG. 4 is a second flow diagram illustrating aspects of the second embodiment of a method of meal planning;

FIG. 5 is a schematic diagram of an example embodiment of a user interface of the system;

FIG. 6 is a schematic flow diagram illustrating aspects of a meal option that may be factored into user meal preference profiles and filters;

FIG. 7 is a schematic flow diagram of example user data flow usable with the system according to an aspect of the disclosure; and

FIG. 8 is a schematic flow diagram of an algorithm flow usable with the system according to an aspect of the disclosure.

### DESCRIPTION OF THE ENABLING EMBODIMENT

Example aspects of meal planning systems and methods embodying the teachings of the present disclosure will now be described more fully with reference to the accompanying drawings. However, the example aspects are only provided so that this disclosure will be thorough, and will fully convey the scope to those who are skilled in the art. Numerous specific details are set forth such as examples of specific components, devices, and methods, to provide a thorough understanding of aspects of the present disclosure. It will be apparent to those skilled in the art that specific details need not be employed, that the example aspects may be embodied in many different forms and that neither should be construed to limit the scope of the disclosure. Features of the embodiments may be combined with one another. In some example aspects, well-known processes, well-known device structures, and well-known technologies are not described in detail.

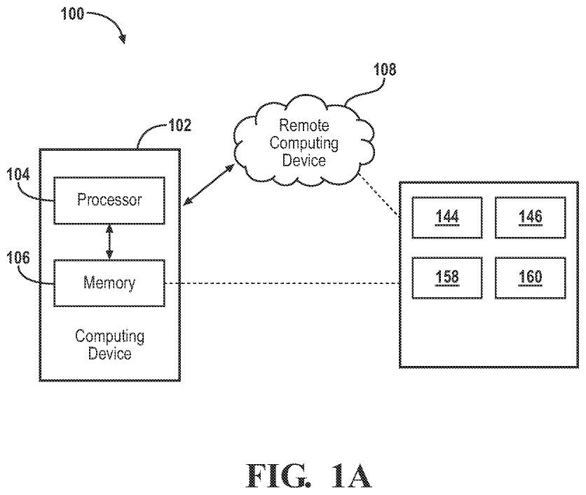

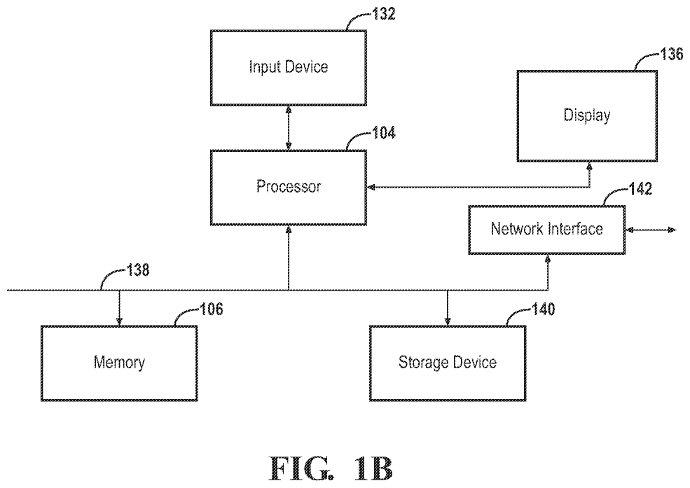

With reference to FIGS. 1A and 1B, a system 100 for planning a meal option, according to the principles of the present disclosure, is generally illustrated. The system 100 may include one or more sending computing devices 102. Each sending computing device 102 may be associated with a sending user. The computing device 102 may include any suitable computing device including preferably a mobile computing device (“mobile device”) (e.g., a smart phone, tablet, laptop computing device), but may also include, a desktop computing device, smart speaker personal assistants (e.g., Amazon Alexa® and Google Home® speakers) or any other suitable computing device. The computing device 102 may include a processor 104 and a memory 106. The processor 104 may include any suitable processor, such as those described herein. Additionally, or alternatively, the computing device 102 may include any suitable number of processors, in addition to or other than the processor 104. The memory 106 may comprise a single disk or a plurality of disks (e.g., hard drives), and include a storage management module that manages one or more partitions within the memory 106. In some embodiments, memory 106 may include flash memory, semiconductor (solid state) memory or the like. The memory 106 may include Random Access Memory (RAM), a Read-Only Memory (ROM), or a combination thereof. The memory 106 may include instructions that, when executed by the processor 104, cause the processor 104 to, at least, perform the functions associated with the systems and methods described herein.

The computing device 102 may include a user input device 132, as is generally illustrated in FIG. 1B, that is configured to receive input from a user of the computing device 102 and to communicate signals representing the input received from the user to the processor 104. For example, the user input device 132 may include a button, keypad, dial, touch screen, audio input interface, visual/image capture input interface, input in the form of sensor data, etc.

The computing device 102 may include a display 136 (e.g., a graphical user interface) that may be controlled by the processor 104 to display information to the user. A data bus 138 may be configured to facilitate data transfer between, at least, a storage device 140 and the processor 104. The computing device 102 may also include a network interface 142 configured to couple or connect the computing device 102 to various other computing devices or network devices via a network connection, such as a wired or wireless connection, or other suitable connection. In some aspects, the network interface 142 includes a wireless transceiver.

The storage device 140 may comprise a single disk or a plurality of disks (e.g., hard drives), one or more solid-state drives, one or more hybrid hard drives, and the like. The storage device 140 may include a storage management module that manages one or more partitions within the storage device 140. In some aspects, storage device 140 may include flash memory, semiconductor (solid state) memory or the like.

The computing device 102 may communicate with a remote computing device 108. The remote computing device 108 may include any suitable computing device or devices, such as a cloud computing device or system, a remotely located server or servers, a remotely or proximately located mobile computing device or application server that provides information to a mobile computing device, other suitable remote computing devices, or a combination thereof. The remote computing device 108 may be remotely located from the computing device 102, such as in a datacenter or other suitable location.

In some aspects, the computing device 102 may retrieve one or more meal planning applications and associated data from the remote computing device 108. For example, the remote computing device 108 may host or provide access to an application repository. The computing device 102 may receive instructions from, for example, input provided by the user, to retrieve (e.g. download) a meal planning application and associated data from the remote computing device 108. In some embodiments, the computing device 102 may receive the instructions to retrieve the meal planning application from another application already disposed on the computing device 102. The computing device 102 may be configured to execute the planning application and/or any other suitable application. For example, the processor 104 may execute instructions stored on the memory 106. The instructions may cause the processor 104 to, at least initiate the meal planning application. The instructions may further cause the processor 104 to perform various functions, such as those described herein, of the meal planning application.

In some aspects, the system 100 and/or the computing devices 102, 108 may perform the methods described herein. However, the methods described herein as performed by the system 100 and/or the computing devices 102, 108 are not meant to be limiting, and any type of software executed on a controller can perform the methods described herein without departing from the scope of this disclosure. For example, a controller, such as a processor executing software within a computing device, can perform the methods described herein.

Generally, the system 100 and methods disclosed herein are used with the goal of quickly, and easily identifying meal options that satisfy an individual or members of a group, such as a family unit. The method is facilitated via the use of computing devices 102, 108. According to a preferred aspect, the system 100 and methods are managed by users via the meal option picking application accessible on the one or more mobile devices 102. The method may also be managed via a website.

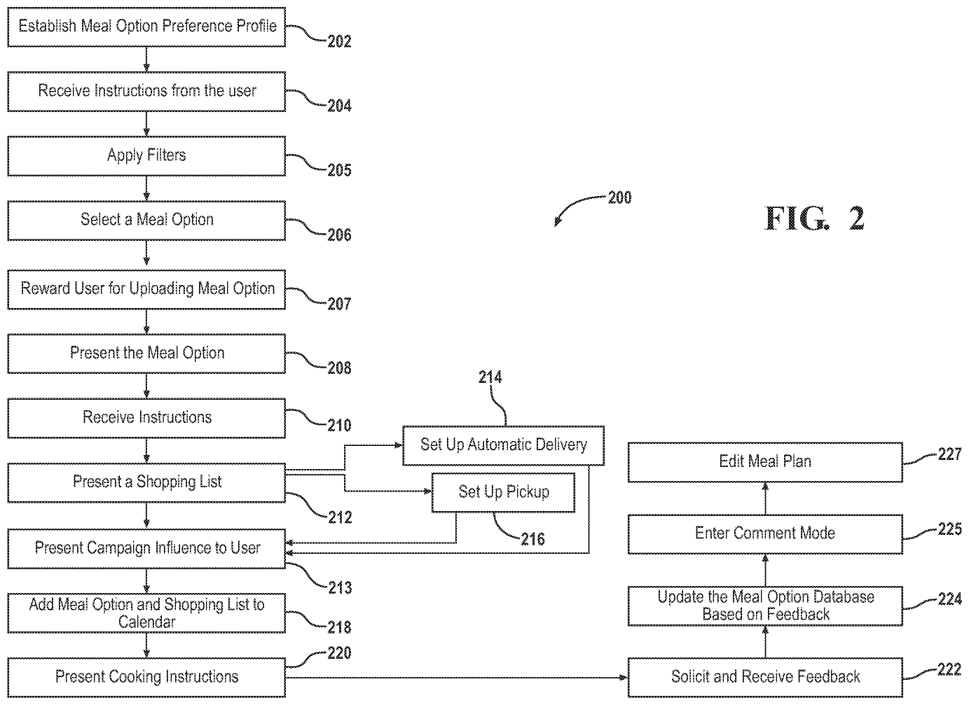

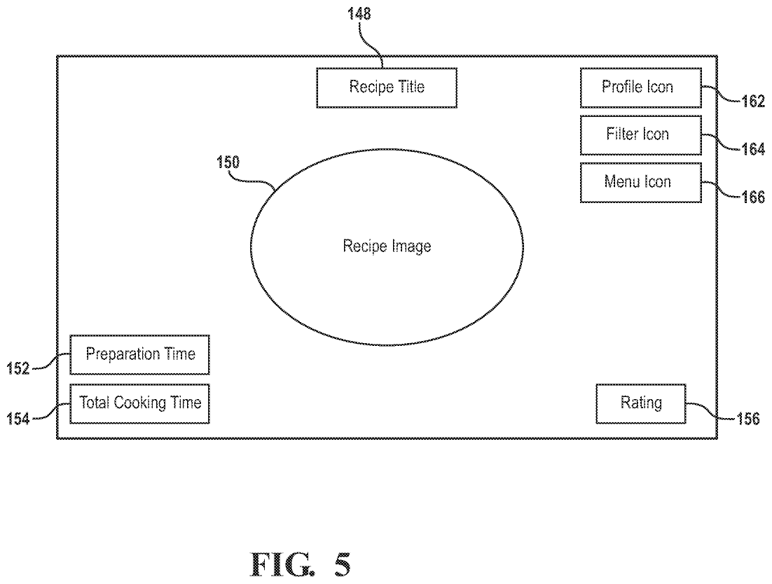

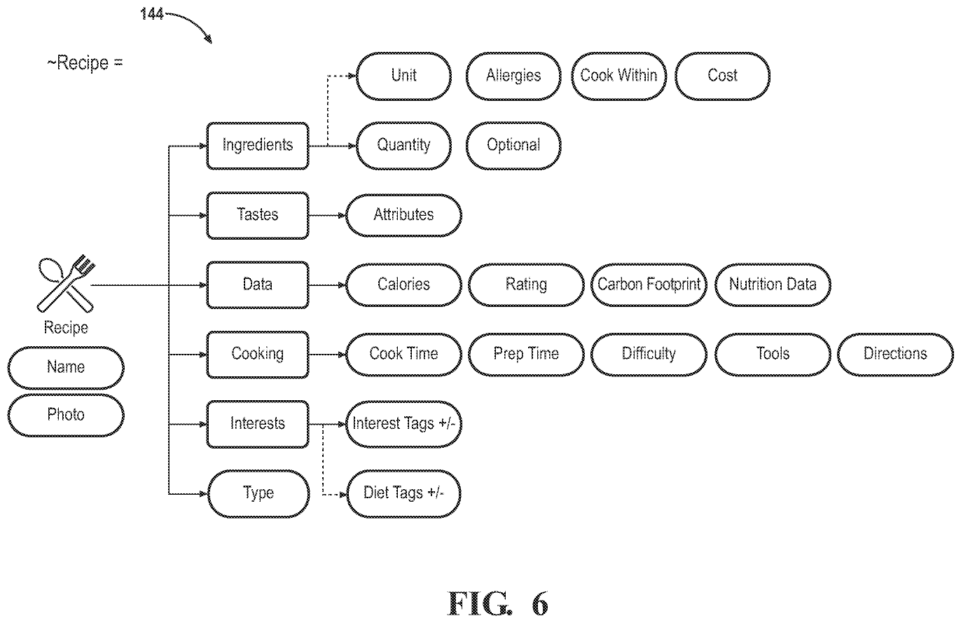

FIG. 2 discloses a first method 200 for planning a meal for a user. The method includes 202 establishing a meal preference profile 144 (schematically shown in FIG. 1A) for a user. The meal preference profile 144 may include, but is not limited to, any of the following parameters: speed of meal preparation, specific tastes, nutritional value, a number of desired servings, dietary restrictions, dietary goals, food available from nearby grocery stores, a balance of an ingredient purchasing fund, an amount of produced waste, a desired leftover amount, type of cuisine, a number of calories in the meal option, specific ingredients, and cooking difficulty. It will be appreciated that a variety of other parameters can be included in the meal preference profile 144. FIG. 6 presents meal option characteristics that all may be part of a meal preference profile 144. Establishing the meal preference profile 144 may include the user entering meal option preference information via the application on the mobile device 102 or via other suitable means. For example, a profile icon 162 (FIG. 5) may be selected to allow the user to edit their meal preference profile 144. The profile icon 162 may also be used to input other types of information, such as household size, local grocery stores, and may provide the operation of modifying current ingredient subscriptions.

The method continues with 204 receiving instructions from the user to generate a meal option from the mobile device 102. Said another way, the user indicates to the application that the user would like to receive a meal option. Receiving instructions from the user may be accomplished through various means including, but not limited to, receiving the request through the app via input on the screen (e.g., graphical user interface) of the mobile device 102 or via a voice command.

At this time, the method may include 205 receiving an input from the user to apply specific filters to present targeted meal options based on the filters. For example, a filter icon 164 (shown in FIG. 5) may be presented on the user interface and selected to permit the user to tailor criteria driving their presented meal suggestions. The filters may include, but are not limited to, a dish type, included ingredients, excluded ingredients, rating, favorites, new meal options, cuisine style, diet style, preparation style, prep time, author, number of servings, cost per serving, calories per servings and ingredient sales. Any of the characteristics listed in FIG. 6 may be used as a filter. The filters may be cumulative with the user's meal preference profile 144, or may be separate, and may constitute a temporary preference. It should be appreciated that filters may be applied at any time throughout the meal option generation process. It will be appreciated that a variety of other filters can be utilized.

The method continues with 206 the computing devices 102/108 selecting a meal option based on the user's meal preference profile 144 and any applied filters. The meal option is selected from a meal option database 146 (schematically shown in FIG. 1A) that includes any number of meal options. Meal options in the meal option database 146 may include, but are not limited to, recipes, meal kit delivery packages, restaurants (generally) and specific items from restaurants. Meal options in the meal option database 146 may be populated from various sources including, but limited to, a host of the application, users of the application, meal option websites (e.g., recipe websites, meal kit delivery websites and restaurant websites/menus), and an artificial intelligence source. For example, meal options may be manually uploaded/entered into the database by users, automatically pulled from various internet sources, or generated via an artificial intelligence source like a chatbot. Selecting a meal option includes using an algorithm to identify a meal option that is consistent with the user's preference profile 144 and applied filters. The selected meal option may be from a “meal option of the day/week/month” list to connect the user with a meal option that both matches the user's meal preference profile 144 and applied filters and is also a currently popular meal option among other users. It will be appreciated that meal options can be selected in a variety of other suitable ways.

According to another aspect of the disclosure, the method may also include 207 rewarding the user for successfully uploading one or more meal options. Various types of rewards may be distributed in different ways. For example, the user may receive a payment for uploading a meal option that is selected by the app to be a meal option that will be presented to other users. As another example, users may be rewarded based on a number of other users that select the uploaded meal option in the app. The app may be configured to display an acknowledgement to the user for creating the meal option.

The method continues with 208 presenting the meal option on the user's mobile device 102. The meal options may be presented on the mobile device visibly (e.g., via a screen) or audibly (e.g., through speakers). The presentation of the meal option may include various scopes of information. According to a preferred embodiment illustrated in FIG. 5, the presentation of the meal option may initially include a title 148, an image 150, an estimated preparation time 152, a total cooking time 154 and a rating 156. According to an aspect of the disclosure, the image 150 of the meal option may be a pre-uploaded/selected picture or generated via an artificial intelligence based image generator. The rating 156 of the meal option may be based on various data sources, such as input from users that previously selected the meal option.

Once the meal option is presented on the user's mobile device 102, the method continues with 210 receiving instructions from the user with the mobile device 102. According to the preferred embodiment, in this step the user is presented with the options of a) selecting the meal option, b) deferring the meal option such that it is not selected at the moment but will show up at a later time, c) receiving additional information about the meal option, and d) discarding the meal option such that it will no longer appear. Additionally, at this time, the method may include receiving input from the user to apply specific filters to present a new meal option based on the filters (as discussed above). Based on the user's input, the method may return to step 208 of presenting a new meal option based on the applied filters.

According to the preferred embodiment, receiving instructions 210 from the user includes the user swiping on the screen of the user device 102 in a first direction to select the meal option, in a second direction to defer the meal option, in a third direction to receive additional information about the meal option, and in a fourth direction to discard the meal option. Other manners of receiving instructions may be employed including, but not limited to, manually entering instructions with a keyboard (part of a screen or separate) of the mobile device 102 or via a voice command.

If the user elects to receive additional information about the meal option, the mobile device may present information including, but not limited to a description of the meal option, a video associated with the meal option, an ingredients list, cooking instructions and pre-selected pairing meal options associated with the meal option.

Upon electing to defer or discard the meal option, the method is configured to revert back to step 208 and present a new meal option any number of times until the user selects a meal option.

Once a meal option is selected, the method may continue with 212 presenting a shopping list of ingredients associated with the meal option, such as on the screen of the mobile device 102 to assist the user in purchasing ingredients. This step includes factoring in how many servings should be prepared in determining an appropriate quantity of ingredients based on input received via the meal preference profile 144 and/or other applied filters. In the event that the meal option is a restaurant or meal kit, this step may not be necessary.

At this point or any another stage of the meal planning process, the method may include the step of 213 presenting a campaign influence to the user. For example, at this stage, the method may include presenting a sponsored item as one or more of the items on the shopping list. For example, a sponsored item may be an item which a provider/manufacturer of the item paid an owner/host of the application to prioritize listing on the shopping list (e.g., if butter is an item on the shopping list, a sponsored brand of butter may be listed). As another example, the application may be programmed to prioritize presenting meal options that use sponsored items, use sponsored cooking tools, meet the requirements of sponsored diet plans, or present sponsored restaurants or meal kits. In accordance with this step, businesses may create “campaigns” within the software that are aimed at users and are intended to influence their purchasing decisions in relation to factors such as ingredient brands, meal kits, restaurants, diet plans, cooking tools, etc. A specific implementation of such a campaign may take the form of a digital coupon that targets consumers that match a certain desired meal preference profile 144. As such, the meal planning application may provide a marketplace for businesses seeking to purchase visibility to consumers.

According to an aspect of the disclosure, at this point the shopping list may be edited via the mobile device 102 by the user in various ways including, but not limited to, adding supplementary items and/or removing items to avoid buying unneeded items, couponing to provide money savings, and sorting items in aisle order of the store in which the items are to be purchased.

According to another aspect of the disclosure, at this stage if the user does not wish to pick out the ingredients themselves, the method may further include 214 setting up an automatic delivery of the ingredients from a store or other storage location to the user. Alternatively, the method may include 216 arranging for the ingredients to be available for pickup by the user at a store or other pickup location.

The method continues with 218 adding the selected meal option and/or the shopping list associated with meal option to an electronic calendar of the user as a reminder of when the meal option is to be made. The same process may be repeated multiple times to populate any number of days on the user's calendar. The method may include positioning meal options that use overlapping ingredients next to one another such that the ingredients are purchased at around the same time, thereby contributing to maintaining ingredient freshness and reducing food storage.

In the event that the selected meal option is a recipe or meal kit, the method may continue with 220 presenting the user with cooking instructions. This can include various videos, images, text and other forms of instruction presented on the screen of the user's mobile device 102 and/or through speakers of the mobile device 102. As previously noted, the instructions may automatically accommodate portion sizes based on an indicated number of servings indicated in the user's meal preference profile 144 and/or applied filters. Cooking instructions may be pre-prepared by a host or user or may be generated via an artificial intelligence source. If the selected meal option is a restaurant, this step may not be necessary.

After preparing/experiencing a meal associated with the selected meal option, the method continues with 222 soliciting and receiving feedback from the user about the meal option. Such feedback can include ratings and comments about the meal options in any number of categories, e.g., preparation time, overall cooking time, flavor, simplicity, etc.

The method continues with 224 updating the meal option database 146 based on the feedback from the user, thus making it more or less likely that the same or similar meal options are recommended in the future. The system 100 may use a model to continuously tailor meal options to the user's preferences over time, thus permitting meal option selections to continuously improve. Various factors may be evaluated in optimizing meal options, including reverse engineering taste profiles based on user feedback. This may include mapping out taste components for future evaluations. In some embodiments, the model may be a collaborative filtering model or any other machine learning model. For instance, one or more machine learning models may be trained using training data to update the meal option database 146. The training data may include labeled inputs (e.g., meal plan information of previous users, the characteristics of previous users, and the feedback progression of the previous users in view of the meal plan) that are mapped to labeled outputs (e.g., the predicted feedback of the user associated with the meal plan). Such training may be referred to as supervised learning. Additional types of training may be used, such as unsupervised learning where the training data is not labeled, and the machine learning models group clusters of the unlabeled training data based on patterns. The patterns may relate to certain characteristics being associated with certain probabilities of eligibilities than other probabilities. In addition, reinforcement learning may be used to train the one or more machine learning models, where a reward is associated with the models correctly determining a probability for one or more characteristics, such that the machine learning models reinforce (e.g., adjusts weights and/or parameters) selecting that probability for those characteristics. In some embodiments, some combination of supervised learning, unsupervised learning, and/or reinforcement learning may be used to train the one or more machine learning models. The same or similar machine learning models may be used throughout the process. For example, a similar model may be followed to present a new meal option in response to a filter being applied by the user.

After completion of at least one meal option as described above or at any other time in the meal preparation process, the method may continue with 225 the user entering a “comment mode” in which they are able to view and comment on meal options they've made. The comment mode may be accessible via a menu icon 166 on the app (shown schematically in FIG. 5). Such comments may selectively be public or private. Comments can be visible within the app of the subject system, other social media apps or various messaging apps. The system may be set up such that sharing can be incentivized (e.g., through rewards or discounts) in order to increase frequency.

After completion of at least one meal option, or at any other time through the process, the method may also include with 227 editing the meal plan. Such edits may be accessed with a menu icon 166 presented on an interface of the app (shown schematically in FIG. 5). For example, the user may select a “plan mode” under which the user can assign meal options to a date on the calendar, remove a meal option, create and save personal meal options, and expand and review meal option details.

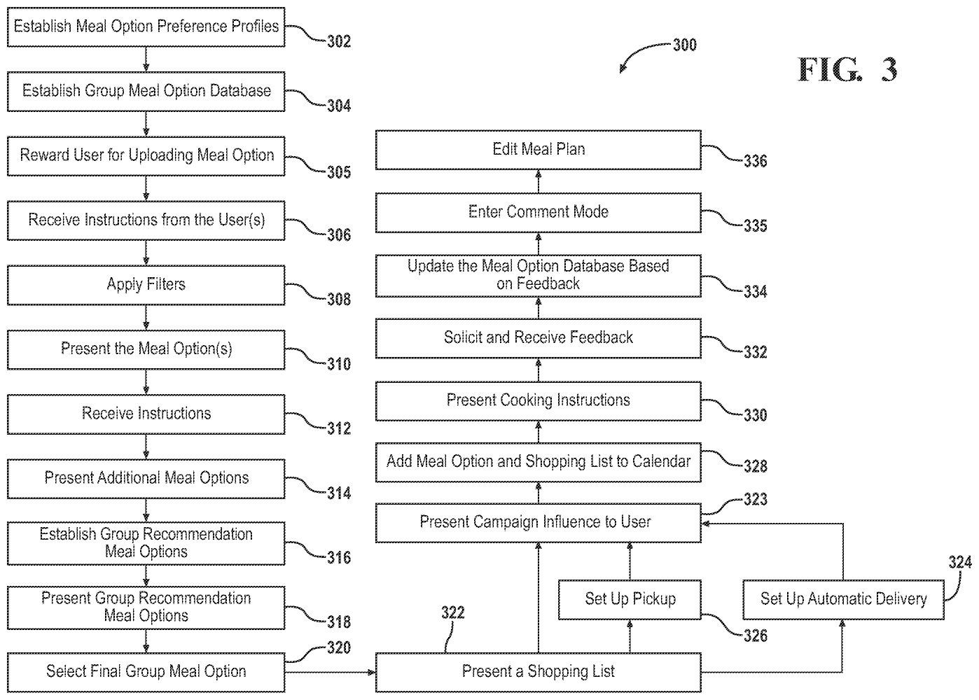

FIG. 3 sets forth a second method 300 of planning a meal, in this case for a group such as a family unit. The method starts with 302 establishing a plurality of meal preference profiles 144 for each of the members of the group. Each of the meal preference profiles 144 may be consistent with that previously described. Meal preference profiles 144 may be established both for users that will actively contribute to selecting meals as well as those who will not.

The method further includes 304 establishing a group meal database 158 (schematically shown in FIG. 1A) that includes a plurality of meal options flagged based on the established meal preference profiles 144. Specifically, an algorithm is applied to select meal options that satisfy at least a predetermined number of preferences/requirements in the user preference profiles 144 of the group. Meal options in the group meal database 158 may include, but are not limited to, recipes, meal kit delivery packages, restaurants (generally), and specific items from restaurants. Meal options in the group meal database 158 may be populated from various sources including, but limited to, a host of the application, users of the application, meal option websites (e.g., recipe websites, meal kit delivery websites and restaurant menus), and an artificial intelligence source. For example, meal options may be manually uploaded/entered into the database 158 by users, automatically pulled from various internet sources, or generated via an artificial intelligence source like a chatbot. According to another aspect of the disclosure, the method may also include 305 rewarding the user for successfully uploading one or more meal options to the group meal database 158. Rewarding the user may be consistent with the reward approach discussed above.

The method continues with 306 receiving instructions from one or more of the members of the group to generate a meal option from one or more mobile devices 102 of the members. Instructions may be received in the same manner as previously described.

The method continues with 308 receiving input from the members of the group to apply specific filters to present new meal options on their mobile devices 102 based on the applied filters. The filters may be the same as those previously noted and may be applied in the same manner. Filters may be applied at any time throughout the meal selection process.

The method continues with the computing devices 102/108 selecting a meal option based on all of the members' meal preference profiles 144 and/or applied filters. The meal option is selected from database group meal database 158. More particularly, selecting a meal option includes using an algorithm to identify a meal option that is consistent with at least a predetermined number of preferences/requirements in the user preference profiles 144 of the group and/or filters.

The method continues with 310 presenting one or more selected meal options on the members' mobile devices 102. Presenting the meal options may be consistent with the approach previously described.

The method continues with 312 receiving instructions from each of the members of the group on how to proceed in association with the presented meal option. According to the preferred embodiment, each of the members are presented with the options of a) selecting the meal option, b) deferring the meal option such that it is not selected at the moment but will show up at a later time, c) receiving additional information about the meal option, and d) discarding the meal option such that it will no longer appear. Additionally, at this time the method may include receiving input from the members to apply specific filters to present new meal options based on the filters (as discussed above). Based on the user's input, the method may return to step 310 of presenting another meal option.

Receiving instructions from each of the members may include each of the members swiping on a screen of the member's mobile device 102 in a first direction to select the meal option, in a second direction to defer the meal option, in a third direction to receive additional information about the meal option, and in a fourth direction to discard the meal option. Other manners of receiving instructions may be employed, including, but not limited to, manually entering instructions with a keyboard of the mobile device 102 and/or issuing a voice command.

Upon electing to select, defer, or discard the meal option, the method continues with 314 presenting additional meal options, and reverting back to step 310 described above a predetermined number of times for each member of the group to establish a bank of group meal options.

After receiving a predetermined number of meal option selections from the members of the group, the method continues with 316 establishing one or more group recommendation meal options 160 (schematically shown in FIG. 1A) based on the selected group meal option options. Various approaches/algorithms may be used to select the group recommendation meal options 160, but they should be focused on accommodating a large/predetermined number of group member preferences from the meal preference profiles 144.

The method may continue with 318 presenting the one or more group recommendation meal options 160 to any or all of the members of the groups. At this point, the group members are provided another opportunity to select, request additional information on, defer or disregard the meal options. At this point the method continues with 320 selecting one or more final group meal options. Various approaches may be taken to select the final group meal option(s) For example, the meal options may be formally selected in response to a majority of group members voting for the meal option. Alternatively, this step may include automatically selecting a final group meal option without additional input from the group.

The method may continue with 322 presenting shopping lists associated with the final group meal options to at least one of the members of the group. This step may be unnecessary if the final group meal option is a restaurant or meal kit. At this point or any another stage of the meal planning process, the method may include the step of 323 presenting a campaign influence to the user. This step may be executed as described above. At this point, the shopping list may be edited in various ways, as previously discussed.

At this stage if the member(s) do not wish to pick out the ingredients themselves, the method may further include 324 setting up an automatic delivery of the ingredients from a store or other storage location to the user. Alternatively, the method may include 326 arranging for the ingredients to be available for pickup by the user at a store or other pickup location.

The method continues with 328 adding the final group meal option(s) and/or the shopping lists associated with meal options to electronic calendars of one of more of the members of the group such that the group members may be reminded of when the meal options are to be prepared. The method may be configured to position meal options that use overlapping ingredients next to one another such that the ingredients are purchased at around the same time, thereby contributing to maintaining ingredient freshness and reducing food storage.

In the event that a recipe or meal kit is selected, the method continues with 330 presenting one or more of the members of the group with cooking instructions, consistent with the previously described cooking instruction approach.

The method continues with 332 soliciting and receiving feedback from each of the members of the group in association with prepared meal options. Such feedback can include a rating of each of the meal options in any number of categories. Feedback may be solicited not just from members that contributed to deciding what meal to select, but also those who exclusively ate the meal. For example, children who only consumed a meal which their parents planned may provide feedback which can used to update a group meal database 158 for the family.

The method continues with 334 updating the group meal database 158 based on the feedback from the members of the group, thus making it more or less likely that the same or similar meal options will be recommended in the future. The system may use a collaborative filtering/machine learning model to continuously tailor meal options to the user's preferences over time as described above, thus improving presented results with time. Such collaborative filtering/machine learning models may be used at any time throughout the process, notably in generating meal options.

After completion of at least one meal option as described above, the method may continue with 335 the users entering a “comment mode” in which they are able to view and comment on meal options they've made. Additionally, the method may proceed with 337 editing the meal plan in accordance with that described above.

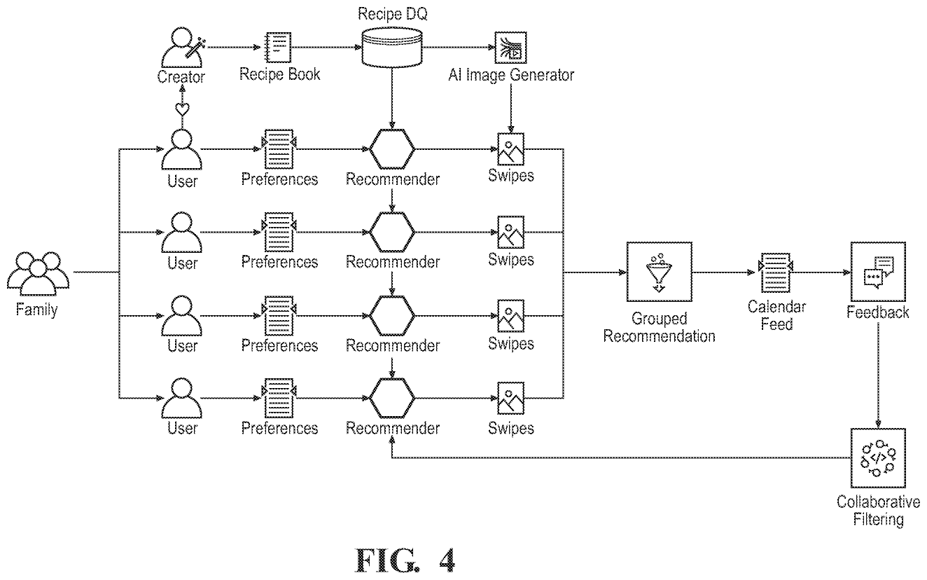

FIG. 4 presents a second schematic flow diagram illustrating aspects of the second method of planning a meal option.

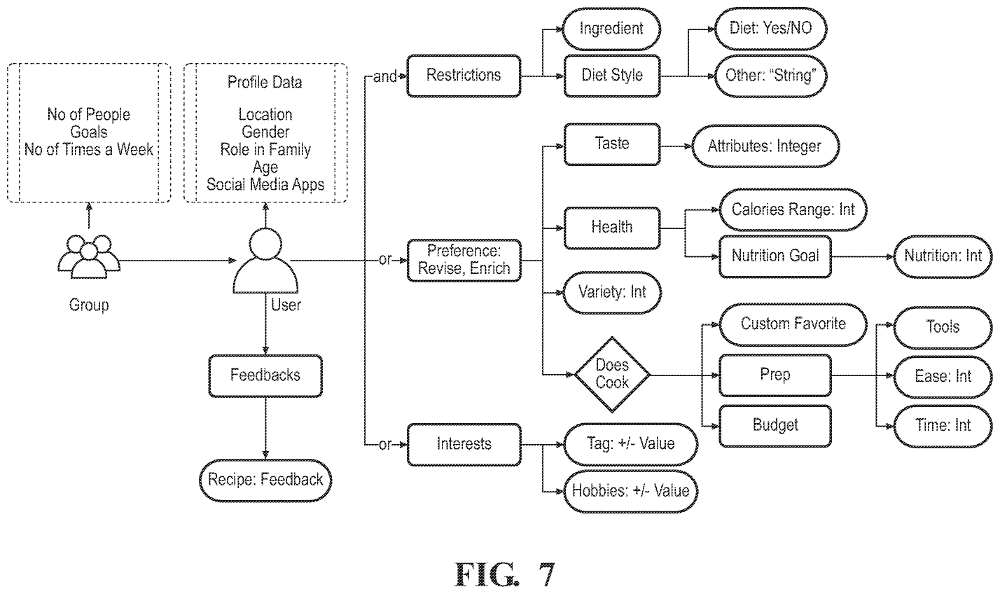

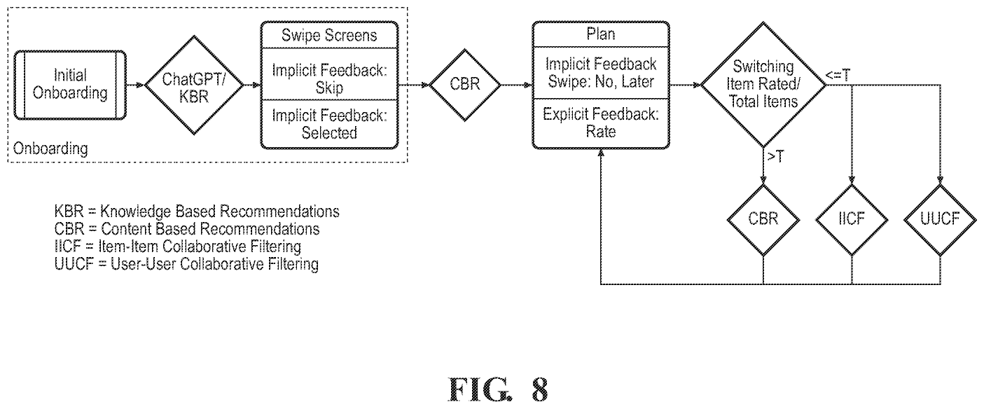

Accordingly, the above method uses a hybrid approach of user experience (UX)/user interface (UI), generative artificial intelligence and collaborative filtering. FIGS. 7 and 8 illustrate schematic diagrams of rich user data flow and an algorithm flow, respectively, according to aspects of the disclosure.

With reference to FIG. 7, according to embodiments, a meal option selection process like that described in the second method above may initially include the step of 400 the group establishing factors such as number of people participating in the meal, a number of meals to generate, and goals (e.g., dietary). These factors may be part of the preference profiles 144 and filters discussed above. Additionally the method includes the 402 individuals establishing their individual preference profiles and filters based on factors including, but not limited to those presented on the rights side of FIG. 7. FIG. 7 also illustrates the process of 404 eliciting feedback from users and factoring it into upcoming meal options.

With reference to FIG. 8, according to embodiments, a meal option selection process like the methods described above may include 500 an initial onboarding step in which users complete tasks like creating the user preference profile 144. The method may also include 502 using an artificial intelligence source to generate/identify meal options to the user(s), such as on mobile device(s) 102 as described above. The method may include 504 employing feedback from the user, e.g., via swiping on the screen of their mobile device 102, and 506 filtering processes to update the meal option database 146 to present additional meal options that are oriented to the user(s), and to establish calendar dates and/or shopping lists. The method may utilize content-based recommendations 506, item-item collaborative filtering 508, and user-user-collaborative filtering 510 to establish these factors.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above discussion is meant to be illustrative of the principles and various embodiments of the present disclosure. Numerous variations and modifications will become apparent to those skilled in the art once the above disclosure is fully appreciated. Features of the various embodiments of the present disclosure are intended to be combinable in various ways. It is intended that the following claims be interpreted to embrace all such variations and modifications.

What is claimed is:

1. A method for planning meals, comprising:
establishing a plurality of recipe preference profiles for a plurality of members of a group;
establishing a group meal database including a plurality of meals flagged based on at least the established recipe preference profiles;
generating and presenting at least one meal option from the group meal database to each of the members of the group with at least one mobile device;
receiving instructions from each of the members of the group with the at least one mobile device as to whether to discard or select the at least one meal option presented to the member;
establishing a group recommendation meal option based on the selections of the at least one meal option among the group;
after finishing the group recommendation meal option, soliciting feedback from each of the members of the group in association with the group recommendation meal option with the at least one mobile device; and
updating the group meal database based on the feedback from the members of the group.

2. The method as set forth in claim 1, wherein presenting the at least one meal option from the group meal database to the members of the group includes presenting the at least one meal option on a screen of a mobile device.

3. The method as set forth in claim 1, wherein the at least one meal option includes a plurality of meal options, and wherein presenting the at least one meal option to the members of the group includes presenting a plurality of the meal options to each of the members of the group.

4. The method as set forth in claim 3, wherein receiving instructions from each of the members of the group includes each of the members of the group swiping a screen of the mobile device in a first direction to discard the meal option presented on the screen of the mobile device, and swiping the screen of the mobile device in a second direction to select the meal option presented on the screen of the mobile device.

5. The method as set forth in claim 1, further including adding the group recommendation meal option to an electronic calendar of at least one of the members of the group.

6. The method as set forth in claim 1, wherein presenting at least one meal option from the group meal database to each of the members of the group includes presenting an image of the at least one meal option on screens of mobile devices of the members of the group.

7. The method as set forth in claim 6, wherein the image of the at least one meal option is generated via an artificial intelligence based image generator.

8. The method as set forth in claim 4, further including the step of receiving instructions from the members of the group as to whether to defer the at least one meal option such that the at least one meal option will be presented at a later time, or to provide additional information about the at least one meal option.

9. The method as set forth in claim 8, wherein providing additional information about the at least one meal option includes presenting at least one of a description of the meal option, a video associated with the meal option, an ingredients list, cooking instructions and pre-selected pairing meal options associated with the meal option.

10. The method as set forth in claim 8, wherein receiving instructions from the members of the group as to whether to defer the at least one meal option includes the members of the group swiping the screen of the mobile device in a third direction, and wherein receiving instructions from the members of the group to provide additional information about the at least one meal option includes the members of the group swiping the screen of the mobile device in a fourth direction.

11. The method as set forth in claim 1, wherein recipe preference profiles of each of the users includes at least one of the following parameters: speed of meal preparation, specific tastes, nutritional value, a number of desired servings, dietary restrictions, dietary goals, food available from nearby grocery stores, a balance of an ingredient purchasing fund, an amount of produced waste, a desired leftover amount, type of cuisine, a number of calories in the meal option, specific ingredients, and cooking difficulty.

12. The method as set forth in claim 1, further including presenting a shopping list on a screen of a mobile device of at least one of the members of the group, wherein the shopping list presents ingredients for the group recommendation meal option.

13. The method as set forth in claim 12, wherein at least one of the ingredients presented on the shopping list is a sponsored item in which a provider of the ingredient paid to have presented on the shopping list.

14. The method as set forth in claim 1, wherein the at least one meal option includes at least one of a recipe, a meal kit delivery package and a restaurant.

15. A method for planning a meal, comprising:
a server computing device comprising:
a processor; and
a memory including instructions that, when executed by the processor, cause the processor to:
establish meal preference profiles for a plurality of members of a group;
establish a group meal database including a plurality of meal options flagged based on the established meal preference profiles;
generate and present at least one meal option from the group meal database to each of the members of the group on at least one mobile device;
receive instructions from each of the members of the group on the at least one mobile device as to whether to discard the at least one meal option presented to the member or select the at least one meal option presented to the member;
establish a group recommendation meal option based on the selections of the at least one meal option among the group;
after the meal option is finished, solicit feedback from each of the members of the group in association with the group recommendation meal option on the at least one mobile device; and
update the group meal database based on the feedback from the members of the group.

16. A method for planning a meal, comprising:
receiving instructions from a user to generate a meal option from a mobile device;
generating a meal option, wherein the meal option is generated based on a user created meal preference profile;
presenting the meal option on the mobile device;
receiving instructions from the user with the mobile device as to whether to discard the meal option or select the meal option, wherein receiving instructions from the user includes the user swiping on a screen of the mobile device in a first direction to discard the meal option, and the user swiping the screen of the mobile device in a second direction to select the meal option; and
wherein if the user elects to discard to the meal option, the method further includes presenting an additional meal option on the mobile device and receiving instructions from the user in association with the additional meal option.

17. The method as set forth in claim 16, wherein receiving instructions from first user includes receiving a voice command from the user or receiving a computer input.

18. The method as set forth in claim 16, wherein the meal preference profile includes at least one of the following parameters: speed of meal preparation, specific tastes, nutritional value, a number of desired servings, dietary restrictions, dietary goals, food available from nearby grocery stores, a balance of an ingredient purchasing fund, an amount of produced waste, a desired leftover amount, type of cuisine, a number of calories in the meal option, specific ingredients, and a cooking difficulty.

19. The method as set forth in claim 16, further including presenting a shopping list of ingredients associated with the meal option on the screen of the mobile device in an event that the user selected the meal option.

20. The method as set forth in claim 16, wherein receiving instructions from the user with the mobile device further includes the user swiping on the screen of the mobile device in a third direction to receive additional information about the meal option.

21. The method as set forth in claim 20, wherein if the user elects to receive additional information about the meal option, the method continues with presenting at least one of a description of the meal option, a video associated with the meal option, an ingredients list, cooking instructions and pre-selected pairing meal options associated with the meal option on the mobile device.

22. The method as set forth in claim 16, wherein the meal option includes at least one of a recipe, a meal kit delivery package and a restaurant.

23. The method as set forth in claim 16, further including presenting cooking instructions for the selected meal option.
